(19) United States
(12) Patent Application Publication
(10) Pub. No.: US 2025/0259232 A1
(43) Pub. Date: Aug. 14, 2025

(54) GRADE-BASED REAL-TIME BIDDING FOR SALES LEADS

(71) Applicant: Leadscorz Inc., Seattle, WA (US)

(72) Inventors: Santiago Diez-Perez, León (ES); Bernard Patrick Murphy, Seattle, WA (US)

(21) Appl. No.: 19/049,936

(22) Filed: Feb. 10, 2025

Related U.S. Application Data
(60) Provisional application No. 63/551,669, filed on Feb. 9, 2024.

(51) Int. Cl. G06Q 30/08; G06Q 30/0202

(52) U.S. Cl. CPC G06Q 30/08; G06Q 30/0202

(57) ABSTRACT

Systems and methods for real-time bidding for leads utilize lead grades from a predictive grading model to calculate optimized bid prices as a function of lead grades. A baseline cost per lead is established. Incoming leads are graded to estimate performance. Bid prices apply boost factors based on lead grades to the cost per lead. Winning bids distribute higher graded leads to buyers. Winning prices adjust the baseline cost per lead over time.

### CROSS REFERENCE TO RELATED APPLICATION

The present application claims priority to U.S. provisional Application No. 63/551,669, entitled “GRADE-BASED REAL-TIME BIDDING FOR SALES LEADS”, filed on Feb. 9, 2024. The entire contents of the above-listed application is hereby incorporated by reference for all purposes.

### TECHNICAL FIELD

The present invention relates to systems and methods for purchasing and distributing sales leads in real time based on dynamically calculated bid prices incorporating lead grades from a predictive grading model. More particularly, the invention relates to integrating lead grading with a real-time bidding system to optimize lead pricing in relation to perceived convertibility/lead quality and purchasing allocations across multiple suppliers.

### BACKGROUND

Currently there are two main strategies employed to bid on sales leads:
Static bidding: For a given lead acquisition campaign, the offered bid stays the same until manually changed by the lead purchaser. This is sometimes referred to as Variable Static Bidding.
Dynamic bidding: For a given campaign the offer varies depending on the previously won or lost bids. This means that the system will increase or decrease the offered price based on previous history of bid outcomes and their impact on achievement of targeted lead acquisition counts for the lead Purchaser, to support their business.

These systems determine acquired lead volume but not lead quality. Even with dynamic bidding, the bid price is only adjusted as a reaction to market pricing fluctuations.

### SUMMARY

One goal of the present invention is to provide a system that allows bidding in real time based on the perceived quality of the presented lead from the perspective of the individual potential purchaser, as determined by the output grade from a Purchaser's predictive grading model, and the status of the Purchaser's demand for new leads based on their current sales pipeline. In accordance with the invention, using a Grading Engine, a grade can be used as an indicator of the expected lead quality in a way that can modify the price of the bid offer to capture higher converting leads on average.

In an illustrative embodiment of the invention, a system and method enable real-time bidding for leads using lead grades output from a predictive grading model. A baseline bid (cost per lead or “CPL”) is established. A lead grading engine grades incoming leads being offered for purchase. Bid prices are calculated by applying a numerical boost factor to the base bid based on the lead grade within a defined grading scale (typically A+ through D−). The boost factor adjusts the bid price based on the expected conversion performance for leads of each grade level. Winning bid prices are tracked to adjust the offered base CPL bids over time.

The present invention offers the following benefits and advantages: With this novel approach, bids are placed based on the expected conversion performance of the lead rather than on the relative “won offer” volume alone. While price may still be adjusted over time to achieve the desired won volume, it can be done in a way that will still incorporate perceived lead quality. For example, bids may be calculated in the following manner to incorporate lead quality into the determination of the bid. In this example, different prices are offered over time based on a dynamic calculation of the offered lead's likelihood to convert. The system will automatically explore different pricing options as to their anticipated outcomes, eventually converging into an offered CPL. For example, the system may automatically process an iterative set of calculations to test different pricing options against targeted “win” percentages. This should result in the acquisition of a population of leads with better performance on average vs the traditional method, and at a price that can be optimal or close to optimal. The invention also provides a more autonomous or systematic approach.

The claimed subject matter is directed to a system, method, and non-transitory computer-readable medium for grade-based real-time bidding for leads. An illustrative embodiment of the inventive system comprises:
A lead intake module (102) configured to receive incoming leads.
A lead grading engine (104) configured to grade the incoming leads using a predictive grading model.
A bid calculation module (106) configured to calculate bid prices for the graded leads by applying a lead grade boost factor to a baseline cost per lead (CPL), wherein the lead grade boost factor is based on the grade assigned by the lead grading engine.
A bidding module (108) configured to submit bids with the calculated bid prices in a real-time bidding exchange.
A lead delivery module (110) configured to deliver won leads to corresponding buyers.
A cost per lead adjustment module (112) configured to adjust the baseline CPL over time based on winning bid prices.

The method and non-transitory computer-readable medium aspects of the inventive system are similar.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a block diagram of a system for grade-based real-time bidding for leads according to one illustrative embodiment; and

FIG. 2 shows a flowchart of a method for grade-based real-time bidding for leads according to the illustrative embodiment.

### DETAILED DESCRIPTION

### Overview

Recent advancements in digital marketing and lead generation have necessitated the development of sophisticated systems for the evaluation and subsequent delivery of sales leads. The present invention builds upon the systems and methods disclosed in U.S. Pat. No. 11,775,912 B2, Oct. 3, 2023, “SYSTEMS AND METHODS FOR REAL-TIME LEAD GRADING”. This system, developed by LeadScorz Inc, provides a foundation for real-time lead grading and outlines a process where leads are graded based on a predictive grading model and then acted on accordingly. This methodology facilitates the identification of leads with a higher likelihood of conversion for a particular Lead Purchaser, thereby streamlining the lead sales process.

The existing technology as set forth in U.S. Pat. No. 11,775,912 B2 significantly enhances lead distribution efficiency by clustering and grading leads using a multi-dimensional vector space representation. This approach, however, primarily focuses on lead grading and does not explicitly address the dynamic pricing of leads in a real-time bidding environment.

The present invention serves as a progression from the aforementioned patent by introducing a system that not only grades leads but also incorporates these grades into a real-time bidding system for lead acquisition. This novel system integrates the predictive lead grades with bid prices that are dynamically calculated, thereby allowing for the optimization of lead pricing and allocation based on the expected conversion performance indicated by the lead grades.

As will be seen below, the present application describes an innovation that bridges the gap between lead grading and lead purchasing by providing a mechanism for grade-based real-time bidding. This approach not only considers the quality of leads but also the cost efficiency for lead buyers in a competitive market environment. By establishing a baseline cost per lead (CPL) and then adjusting the bid prices with a boost factor influenced by the lead grades, the system ensures acquisition/purchasing is both price-sensitive and quality-focused.

The proposed system advances the technical field of lead distribution by enabling a more fluid and economically driven marketplace for leads, where the value of a lead is directly tied to its potential for conversion. This leads to an enhanced return on investment for buyers and a fairer, more dynamic pricing model for sellers of leads.

### System Architecture

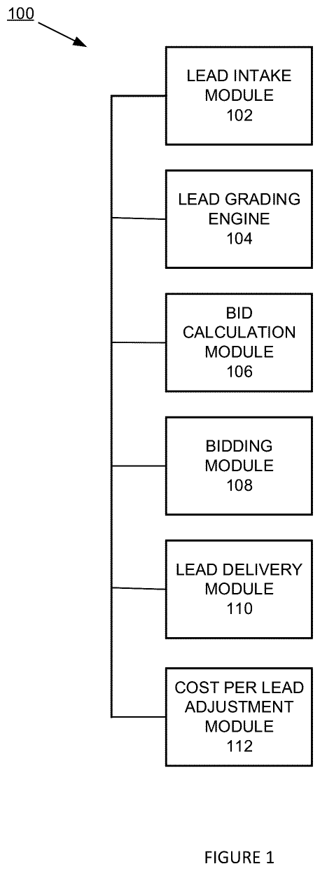

FIG. 1 shows a system 100 for grade-based real-time bidding for leads according to one embodiment. The system includes a lead intake module 102, a lead grading engine 104, a bid calculation module 106, a bidding module 108, a lead delivery module 110, and a cost per lead adjustment module 112.

The lead intake module 102 receives incoming leads available for purchase, for example from multiple third-party lead generation sources. The leads may include information such as consumer contact information, product interests, attributes, demographic data, and more.

The lead grading engine 104 analyzes the incoming leads using a predictive grading model. The grading model may apply various machine learning to assign a grade or score to each lead indicative of expected lead performance. For example, higher graded leads may have higher engagement/conversion rates, and therefore greater revenue potential.

The bid calculation module 106 calculates a bid price for each graded lead. It starts with a baseline cost per lead (CPL) and applies a lead grade boost factor to determine the bid price. Leads with higher grades get higher boost factors and thus higher bid prices. The boost factors are calibrated to optimize conversion performance. In the illustrative embodiment, the system assumes a static CPL for all leads. The bid is then a function that uses the static CPL, the grade and the desired volume. This baseline CPL should be the same, or close to, the target CPL (how much a customer is willing to pay for leads on average).

The bidding module 108 submits bids for the leads in a real-time bidding exchange. Bids compete against buyers in the exchange. Winning bids result in leads being delivered to the corresponding buyer.

The lead delivery module 110 delivers the won leads to the buyer for further processing, contacting, and conversion by sales teams. Performance metrics are tracked—and incorporated into the system.

The cost per lead adjustment module 112 adjusts the baseline CPL over time based on winning bid prices. If bids are being consistently won above the CPL, it may increase. If consistently winning below CPL, it may decrease. This balances volume and quality over time.

### Operation

The operation of the system will now be described. The following definitions are assumed:
Cost Per Lead (CPL): Price paid for each lead on average;
Conversion Rate (CR): Percentage of leads that achieve a “conversion event” as defined by the Predictive Grading Model (may be a “qualification action, or an actual sale);
Cost Per Sale (CPS): The average amount of money expended buying leads to get a Sale. CPS=CPL/CR;
Lead Grade (G): A category assigned to a lead using a Grading Engine, based on the expected performance of the leads within that category compared to the rest;
Lead Grade Boost Factor (BF): How much better or worse the expected performance of a group of leads will be, compared to the entire population of leads; and
Winning Price Probability Distribution (W): The expected probability of winning a bid based on the price of the offer.

### System Operation

A baseline CPL will be established using historical records to get the historical CR and based on the desired CPS.
A Grading Engine will be created using historical records.
W will be initialized as a standard normal distribution with the mean equal to the baseline CPL.
Offering a Bid:
   i. Using the data in the Bid request, a Lead Grade (G) will be calculated.
   ii. If G is above the quality threshold, a Bid is offered.
   iii. The Bid Price will be calculated using the Lead Grade Boost Factor and the CPL. Bid Price=BF×CPL.
   iv. The result of the bid is stored to adjust the CPL.
Adjusting the CPL:
   i. After a number of observations, a new W will be calculated.
   ii. The new CPL will be the mean of W.

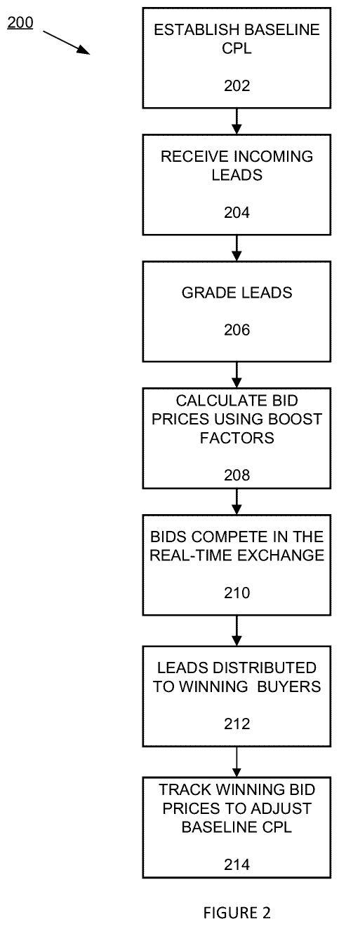

FIG. 2 is a flow diagram depicting a method 200 for grade-based real-time bidding for leads according to one embodiment. First, a baseline CPL is established (202). The lead intake module receives incoming leads (204) which are graded by the lead grading engine (206).

Bid prices are calculated by applying boost factors to the CPL based on the grades (208). The bids compete in the real-time exchange (210). Leads are distributed to winning buyers (212). Winning bid prices are tracked to adjust the baseline CPL (214). The process repeats for additional leads.

By integrating predictive lead grading with real-time bidding, the system balances lead volume, cost, and conversion quality over time. The lead grade boost factors optimize bid pricing. This enhances return on investment in leads.

### CONCLUSION

The systems and methods described herein provide significant benefits and advantages over conventional lead acquisition, delivery, distribution and purchasing allocations among lead suppliers. By integrating predictive lead grading with real-time bidding, the invention enables dynamic pricing and allocation of leads based on estimated conversion performance. This allows lead buyers to acquire higher quality leads that are more likely to convert to sales, thereby improving return on investment. At the same time, it provides a fairer and more dynamic pricing model for lead sellers that is directly tied to lead performance.

The use of boost factor values, based on a calculation of a lead's relative propensity to convert when applied to a baseline CPL to calculate bid prices, is a novel technique that balances cost efficiency and conversion rate optimization. The continuous adjustment of the baseline CPL based on winning bid prices further refines this balance over time in response to market conditions. This invention encompasses an autonomous and fluid lead marketplace that was not previously achievable.

Additionally, while specific system architecture and flow logic have been described, the invention could also be embodied in many other forms and implementations. The lead grading techniques, bid price calculations, bidding mechanisms, and baseline CPL adjustments could be realized through various equivalent means. The specific embodiments described herein should therefore be considered illustrative rather than restrictive.

In summary, by bridging the gap between lead generation, lead valuation, and the competitive acquisition of leads, the present invention represents a substantial advancement to the technological field of digital lead purchasing and distribution. The integration of these concepts provides significant commercial value to both suppliers and consumers of high-quality leads.

Aspects of the disclosure may operate on particularly created hardware, firmware, digital signal processors, or on a specially programmed computer including a processor operating according to programmed instructions. The terms controller or processor as used herein are intended to include microprocessors, microcomputers, Application Specific Integrated Circuits (ASICs), and dedicated hardware controllers.

One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a computer readable storage medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGAs, and the like.

Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or computer-readable storage media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

The previously described versions of the disclosed subject matter have many advantages that were either described or would be apparent to a person of ordinary skill. Even so, these advantages or features are not required in all versions of the disclosed apparatus, systems, or methods.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

Although specific examples of the invention have been illustrated and described for purposes of illustration, it will be understood that various modifications may be made without departing from the spirit and scope of the invention. Accordingly, the invention should not be limited except as by the appended claims.

1. A system for grade-based real-time bidding for leads, comprising:
a lead intake module configured to receive incoming leads;
a lead grading engine configured to grade the incoming leads using a predictive grading model;
a bid calculation module configured to calculate bid prices for the graded leads by applying a lead grade boost factor to a baseline cost per lead (CPL), wherein the lead grade boost factor is based on the grade assigned by the lead grading engine;
a bidding module configured to submit bids with the calculated bid prices in a real-time bidding exchange;
a lead delivery module configured to deliver won leads to corresponding buyers; and
a cost per lead adjustment module configured to adjust the baseline CPL over time based on winning bid prices.

2. The system of claim 1, wherein the lead grading engine is configured to assign a grade to each lead indicative of expected lead performance.

3. The system of claim 2, wherein the expected lead performance includes at least one of conversion rate and revenue potential.

4. The system of claim 1, wherein the bid calculation module is configured to apply higher boost factors to leads with higher grades.

5. The system of claim 1, wherein the cost per lead adjustment module is configured to increase the baseline CPL if bids are consistently won above the CPL and decrease the baseline CPL if bids are consistently won below the CPL.

6. The system of claim 1, wherein the bidding module is configured to submit bids only for leads with grades above a quality threshold.

7. The system of claim 1, further comprising a module configured to track performance metrics of delivered leads.

8. The system of claim 1, wherein the lead grade boost factor is calibrated to optimize conversion performance.

9. The system of claim 1, wherein the lead grading engine is configured to use machine learning techniques to assign grades to leads.

10. The system of claim 1, wherein the bid calculation module is configured to calculate the bid price as the product of the lead grade boost factor and the baseline CPL.

11. A method for grade-based real-time bidding for leads, comprising:
receiving incoming leads;
grading the incoming leads using a predictive grading model;
calculating bid prices for the graded leads by applying a lead grade boost factor to a baseline cost per lead (CPL), wherein the lead grade boost factor is based on the grade assigned by the predictive grading model;
submitting bids with the calculated bid prices in a real-time bidding exchange;
delivering won leads to corresponding buyers; and
adjusting the baseline CPL over time based on winning bid prices.

12. The method of claim 11, further comprising establishing an initial baseline CPL prior to receiving incoming leads.

13. The method of claim 11, wherein grading the incoming leads comprises assigning a grade to each lead indicative of expected lead performance.

14. The method of claim 13, wherein the expected lead performance includes at least one of conversion rate and revenue potential.

15. The method of claim 11, wherein calculating bid prices comprises applying higher boost factors to leads with higher grades.

16. The method of claim 11, wherein adjusting the baseline CPL comprises increasing the baseline CPL if bids are consistently won above the CPL and decreasing the baseline CPL if bids are consistently won below the CPL.

17. The method of claim 11, further comprising submitting bids only for leads with grades above a quality threshold.

18. The method of claim 11, further comprising tracking performance metrics of delivered leads.

19. The method of claim 11, wherein the lead grade boost factor is calibrated to optimize conversion performance.

20. The method of claim 11, wherein grading the incoming leads comprises using machine learning techniques to assign grades to leads.

21. A non-transitory computer-readable medium storing instructions that, when executed by a processor, cause the processor to perform a method for grade-based real-time bidding for leads, the method comprising:
receiving incoming leads;
grading the incoming leads using a predictive grading model;
calculating bid prices for the graded leads by applying a lead grade boost factor to a baseline cost per lead (CPL), wherein the lead grade boost factor is based on the grade assigned by the predictive grading model;
submitting bids with the calculated bid prices in a real-time bidding exchange;
delivering won leads to corresponding buyers; and
adjusting the baseline CPL over time based on winning bid prices.

22. The non-transitory computer-readable medium of claim 21, wherein the method further comprises establishing an initial baseline CPL prior to receiving incoming leads.

23. The non-transitory computer-readable medium of claim 21, wherein grading the incoming leads comprises assigning a grade to each lead indicative of expected lead performance.

24. The non-transitory computer-readable medium of claim 21, wherein calculating bid prices comprises applying higher boost factors to leads with higher grades.

25. The non-transitory computer-readable medium of claim 21, wherein calculating bid prices comprises applying higher boost factors to leads with higher grades.

26. The non-transitory computer-readable medium of claim 21, wherein adjusting the baseline CPL comprises increasing the baseline CPL if bids are consistently won above the CPL and decreasing the baseline CPL if bids are consistently won below the CPL.

27. The non-transitory computer-readable medium of claim 21, wherein the method further comprises submitting bids only for leads with grades above a quality threshold.

28. The non-transitory computer-readable medium of claim 21, wherein the method further comprises tracking performance metrics of delivered leads.

29. The non-transitory computer-readable medium of claim 21, wherein the lead grade boost factor is calibrated to optimize conversion performance.
